(19) United States
(12) Patent Application Publication
(10) Pub. No.: US 2019/0068681 A1
(43) Pub. Date: Feb. 28, 2019

(54) SOFTWARE APPLICATION FOR COOKING

(71) Applicant: WHIRLPOOL CORPORATION, Benton Harbor, MI (US)

(72) Inventors: Daniel P. BOYCE, Lawton, MI (US); Wyndham F. GARY, JR., St. Joseph, MI (US); Richard J. HUGHES, St. Joseph, MI (US); Melanie L. RILEY, St. Joseph, MI (US)

(21) Appl. No.: 15/683,961

(22) Filed: Aug. 23, 2017

(51) Int. Cl. H04L 29/08; H05B 6/64; G06F 17/30; H05B 6/06

(52) U.S. Cl. CPC H04L 67/025; H05B 6/6435; H05B 2213/06; H05B 6/062; G06F 17/30

(57) ABSTRACT

A software application for generating cooking instructions for a food item can comprise an input module identifying the food item, a query module to query a cooking instruction database based on the input and return cooking instructions for the food item, and an output module to output the cooking instructions.

### BACKGROUND OF THE INVENTION

The disclosure relates to components and accessories for a communicating appliance.

Household appliances typically comprise one or more components responsible for the electromechanical operations of the appliance. For example, an oven can include an appliance management component having a printed circuit board (PCB) with memory, as well as a user-interface component, such as a control panel or keypad, for a user to issue commands to the oven.

Prepackaged foods typically include preparation instructions for multiple appliances, such as one set of instructions for stovetop use and another set of instructions for use with microwave ovens. It can be beneficial to simplify food preparation by utilizing automation capabilities of appliances having electronic control and communication systems.

### SUMMARY OF THE INVENTION

In one aspect, a software application for generating cooking instructions for a food item, the software application comprises an input module comprising executable instructions to receive an input identifying the food item, a query module comprising executable instructions to query a cooking instruction database based on the input and return cooking instruction with a pre-heat step for the food item, a conversion module comprising executable instructions that convert the cooking instructions to modified cooking instructions without a pre-heat step, and an output module comprising executable instructions outputting the modified cooking instructions.

In another aspect, a system of networked appliances for implementing cooking instructions for a prepackaged food item in a cooking appliance comprises an imaging device scanner configured to read an input associated with the prepackaged food item, a cooking instruction database comprising a list of prepackaged food cooking instructions, a query module comprising executable instructions to query the cooking instruction database based on the input and return cooking instruction for the prepackaged food item, a conversion module comprising executable instructions that convert the cooking instructions to modified cooking instructions, and at least one an appliance configured to receive the modified cooking instructions.

In another aspect, a method of implementing cooking instructions on prepackaged foods by way of an application executed on a mobile device comprises receiving on a processor an input from the application, querying a database for a list of cooking instructions associated with the input, converting the cooking instructions into modified cooking instructions for use in a non-preheated appliance, outputting the modified cooking instructions; and receiving in one of an appliance or a mobile device the modified cooking instructions.

### BRIEF DESCRIPTION OF THE DRAWINGS

In the drawings:

FIG. 1 is a schematic view of a network for exchanging information between a mobile device, a server, and an appliance.

FIG. 2 is a schematic view of a software application in the mobile device of FIG. 1 according to various aspects described herein.

FIG. 3 is a flowchart illustrating a module of the software application of FIG. 2.

FIG. 4 is a schematic view of a mobile interactive display illustrating a first aspect of the software application of FIG. 2.

FIG. 5 is a schematic view of a mobile interactive display illustrating a second aspect of the software application of FIG. 2.

FIG. 6 is a schematic view of a mobile interactive display illustrating a third aspect of the software application of FIG. 2.

FIG. 7 is a schematic view of a mobile interactive display illustrating a fourth aspect of the software application of FIG. 2.

FIG. 8 is a schematic view of networked appliances utilizing the software application of FIG. 2.

### DESCRIPTION OF EMBODIMENTS OF THE INVENTION

A network can include servers, appliances, and mobile devices that can be in communication over a communications network, such as a middleware or cloud storage. An application programing interface (API), herein referred to as a “software application” or “app”, can access the communications network in which digital data from servers can be stored. The app can use a processor on a mobile device to execute instructions and communicate with the network. Additionally, the app can use an interactive display or user interface on the mobile device to allow for user input or customization.

Databases stored in the communications network can include data relating to a set of cooking instructions for prepackaged food items which are accessible via the software application. A cooking instruction database can include information such as recommended appliances for preparing the food item and cooking times, as well as user intervention steps such as stirring or removing an outer wrapper from the food item.

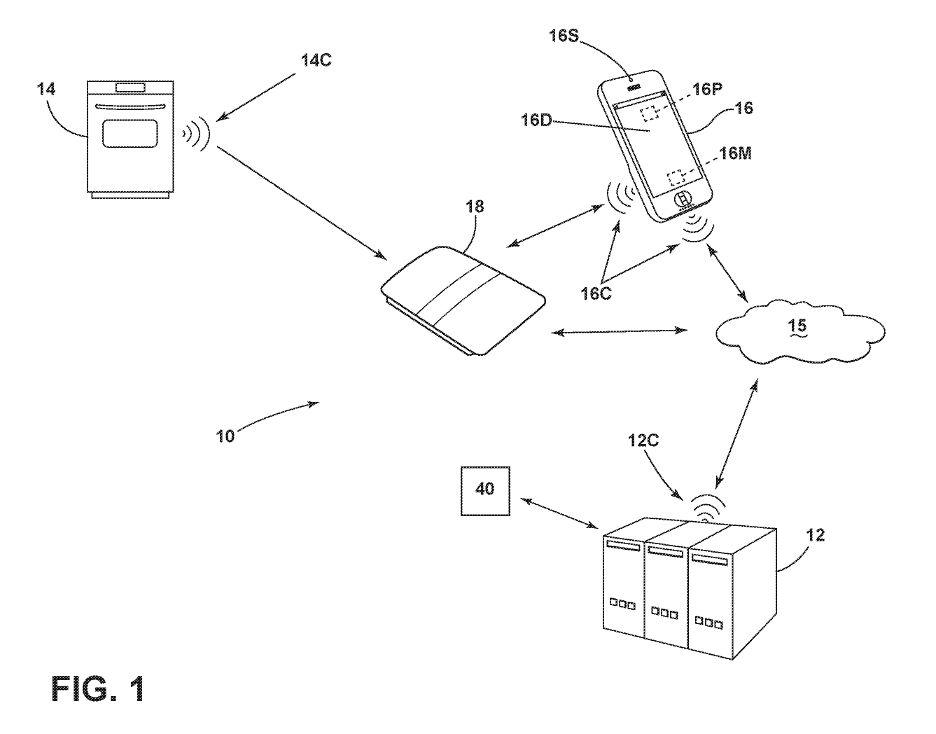

FIG. 1 is a schematic view of a data network 10 according to one aspect of the disclosure. The network 10 can include wired, wireless, or a combination of wired and wireless points or nodes to connect communication paths for exchanging and transporting data. The network 10 can also include one or more networks 10 in communication with each other. Nodes in the network 10 include a server 12 in network communication via a server communication module 12C, an appliance 14, a mobile device 16, and a communications network 15 such as the Internet. The server communication module 12C enables wired or wireless connection to the communications network 15 and provides for the exchange of information and data between the server 12, the appliance 14, and/or the mobile device 16.

The server 12 can be a general purpose computer or server used by a manufacturer, provider, or retailer of goods or services, and can communicate information and data to the network 10 as well as provide access to various databases accessible by or stored on the server 12. The databases can include particularized information, such as a cooking instructions database 40 containing a listing of cooking instructions for prepackaged foods searchable by the app user. It will be understood that other databases (not illustrated) can be included on the server 12, such as a companion database containing a list of augmented cooking instructions for prepackaged foods, such as the addition of fresh ingredients or combination recipes combining one or more prepackaged foods, in non-limiting examples.

The server 12 can be configured to query the database 40 for information. The server 12 can also have a memory that stores information such that the database 40; alternatively, the server 12 could be in network communication with the database 40. The server 12 can also be used to search, generate, or otherwise send data, including a message, SMS, or MMS in non-limiting examples, over the network 10 to the appliance 14 or the mobile device 16. While only one server 12 is shown in FIG. 1, it should be understood that the network 10 can include multiple servers 12. The server 12 can also communicate with one or more utility providers, retailers, or manufacturers via the communication network 15 and, in the case where the communications network 15 is the Internet, the server 12, database 40, appliance 14, and mobile device 16 can all be in the same communication network 19.

The appliance 14 can comprise any home appliance used for cooking or preparing food. Non-limiting examples of the appliance 14 include an oven, toaster oven, cooktop, or microwave, and it is contemplated that the appliance 14 can include a food preparation element such as a mixing or stirring element. The appliance communication module 14C can provide for data communication with the server 12 or mobile device 16, using wired or wireless connections where appropriate. The appliance 14 can also include components such as an access door, heating element, timer, or temperature control, and such components will not be described further herein except as necessary for a complete understanding of the disclosure.

The mobile device 16 can comprise a processor 16P, memory 16M, and imaging device 16S, and can be capable of communicating with the network 10 via a mobile communication module 16C including an antenna or receiver. The mobile device 16 can send and receive messages and data, including text, SMS, MMS, or other types of messages, and also transmit or receive data in a form that can be translated and displayed as a message. The imaging device 16S can comprise a camera, an optical scanner, or a near-field-communication (NFC) reader in non-limiting examples, and can be capable of scanning a barcode or capturing an image in order to read an indicia. Mobile devices 16 also typically comprise a mobile interactive display 16D which can provide users with access and control of the mobile device 16. While the mobile device 16 is illustrated and generally described in relation to a mobile phone, it can, for example, comprise a smartphone, a tablet computer, a desktop computer, or a notebook computer.

A router 18 is typically used in a home environment, and can provide wired or wireless communication between the appliance 14, mobile device 16, and communication network 15. The router 18 can exchange data and information from the mobile device 16 or appliance 14 with the communication network 15, which can exchange information with the server 12 as needed. Therefore, the appliance 14, mobile device 16, and server 12 can all be in communication with each other through the communication network 15.

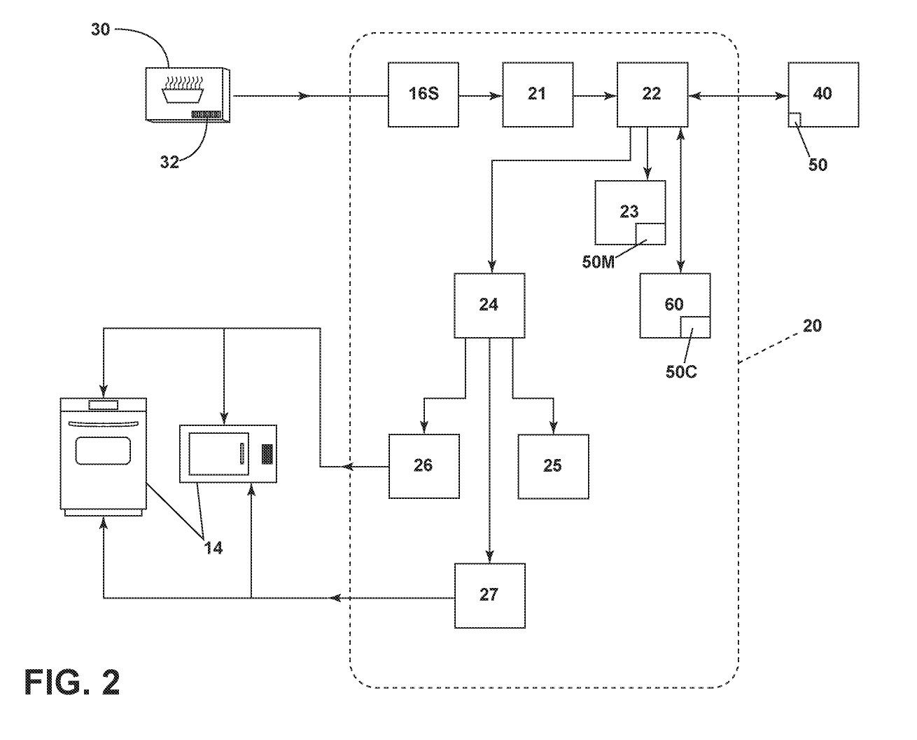

Turning to FIG. 2, a software application 20 in the mobile device 16 can comprise an input module 21, a query module 22, a conversion module 23, an output module 24, a display module 25, a transmission module 26, and a remote start module 27.

The imaging device 16S in the mobile device 16 can be used to image a prepackaged food item 30, illustrated as scanning a barcode 32 on the food item 30. The input module 21 can include executable instructions to receive the barcode information identifying the food item 30. The query module 22 can include executable instructions to query the database 40 based on the barcode information, and cooking instructions 50 for the food item 30 can be transmitted from the database 40 to the query module 22.

It will be appreciated that while illustrated as receiving a barcode 32, the input module 21 can receive any type of identifier for the food item 30 including a QR code, near-field-communication tag, text, numerical code, or image, in non-limiting examples.

The cooking instructions 50 for the food item 30 can include options for a variety of appliances, such as one set of instructions for cooking in a microwave and another set of instructions for baking in an oven or even a third set of instructions for cooking in a toaster oven. In an example where an oven pre-heating step is present, a conversion module 23 of the application 20 can convert the cooking instructions 50 into modified cooking instructions 50M that do not include a pre-heating step. In such a case, the modified cooking instructions 50M can allow for the food item 30 to be placed in a non-preheated oven such as the appliance 14 and baked accordingly. In another non-limiting example where cooking instructions 50 include a single baking step, such as “Bake at 350 degrees for 45 minutes,” the conversion module 23 can generate modified cooking instructions 50M that include multiple baking stages such as “Bake at 375 degrees for 20 minutes, then bake at 300 degrees for 30 minutes.”

It is further contemplated that the conversion module 23 can convert the cooking instructions 50 based on a particular appliance. In one example, the cooking instructions 50 for the food item 30 can include a cooking time based on an 800 W microwave oven, and the conversion module 23 can perform a conversion to prepare the food item 30 in an 1100 W microwave oven. In another example, the cooking instructions 50 can include a cooking time based on a microwave oven operating at its maximum power level, and the conversion module 23 can perform a conversion to cook the food item 30 at a reduced power level for an increased amount of time. It will be understood that the conversion module 23 can perform other conversions in the spirit of the present disclosure.

Additionally, a user can update attributes of the cooking instructions 50, such as cooking time or quantity of food items 30 being cooked at a time, and generate custom cooking instructions 50C that can be stored in a custom library 60. The custom library 60 can be stored in the mobile device memory 26M (FIG. 1), in the server 12 (FIG. 1), in the appliance 14, or in any suitable electronic storage medium in data communication with the application 20 as desired. In non-limiting examples the custom library 60 can also include a list of favorite, frequently-prepared, or recently-prepared food items 30, and the custom library 60 can also be sorted by appliance type or food type as desired. In yet another example, the server 12 can include an aggregated, user-submitted, set of modifications to the cooking instructions 50. In such a case, the query module 22 can return the user-submitted modifications along with the cooking instructions 50, and the conversion module 23 can include the user-submitted modifications when generating the modified cooking instructions 50M or custom cooking instructions 50C.

The cooking instructions 50, 50M, 50C can be transmitted to an output module 24 having executable instructions to output the cooking instructions 50, 50M, 50C to a desired location. A display module 25 can prepare the cooking instructions 50, 50M, 50C for display on a screen, such as the interactive display 16D (FIG. 1) or a screen on an appliance 14 as desired.

A transmission module 26 can transmit any version or all of the cooking instructions 50, 50M, 50C to all appliances 14 capable of cooking the food item 30. In another example, a user can pre-select a desired appliance 14 for the transmission module 26 to transmit to. Furthermore, the transmission module 26 can transmit the cooking instructions 50, 50M, 50C to a second mobile device (not illustrated). In such a case, the cooking instructions 50, 50M, 50C can be formatted or optimized for viewing on the second mobile device. It should be understood that other examples in the spirit of the present disclosure are contemplated for use in the software application 20.

A remote start module 27 can include executable instructions to turn on the appliance 14 remotely, such as turning on an oven or starting a microwave, as well as specifying a time duration or intervals at particular temperatures, in non-limiting examples.

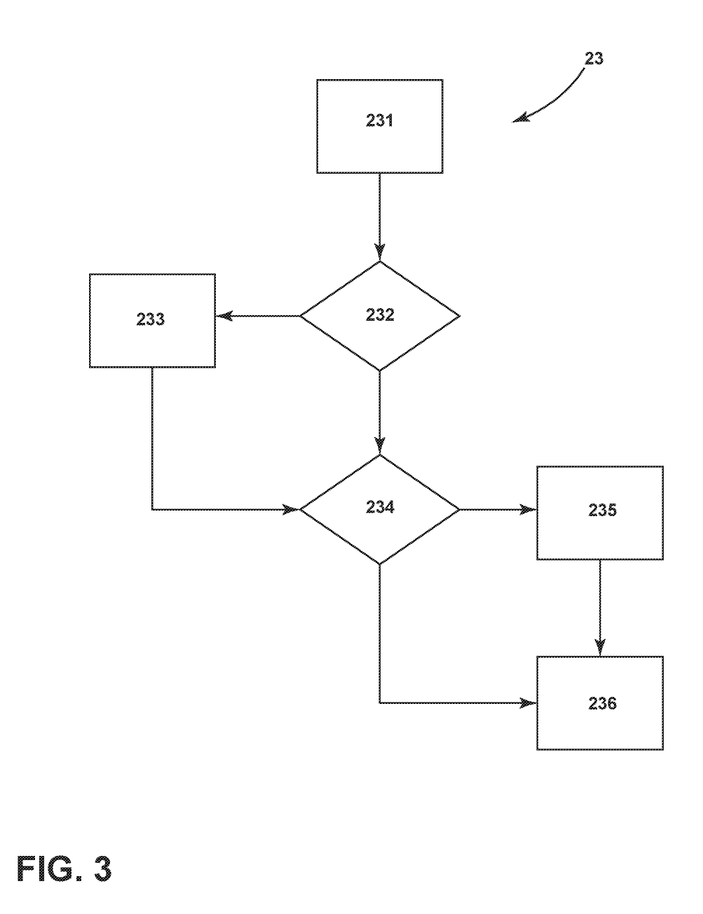

FIG. 3 further illustrates the conversion module 23. At 231, the cooking instructions 50 are received as input to the conversion module 23. At 232 the cooking instructions 50 can be checked for a pre-heating step; if found, modified cooking instructions 50M can be generated at 233 to remove the pre-heating step and adjust cooking times or temperatures as appropriate. At 234 the conversion module 23 can check the quantity of prepackaged food items 30 being cooked. In an example where cooking instructions 50 reflect cooking a single food item 30, and a user desires to cook more than one of a given food item 30 simultaneously, the conversion module can generate custom cooking instructions 30C at 235 for the desired quantity. It is also contemplated that modified cooking instructions 50M can be converted to custom cooking instructions 50C. In a non-limiting example, a user may desire to cook multiple food items 30 whose cooking instructions 50 include a pre-heat step. The conversion module can remove the pre-heat step at 233 to generate modified cooking instructions 50M, and further generate custom cooking instructions 50C at 235 to reflect the quantity of items. It should be appreciated that other types of conversions can be performed by the conversion module 23. In non-limiting examples, conversions can be performed to add or remove user intervention steps or other food preparation steps such as removal of film coverings, stirring of contents, or addition of ingredients to the prepackaged food item 30, in non-limiting examples.

It is further contemplated that cooking instructions 50 containing multiple steps can be converted into modified cooking instructions 50M containing a single user step, such as placing a food item 30 in an appliance 14 and pressing a start button on the appliance 14 without the need for pre-heating. In such a case, the appliance 14 can have computation and control circuitry to automatically adjust a cooking time or temperature without additional user intervention.

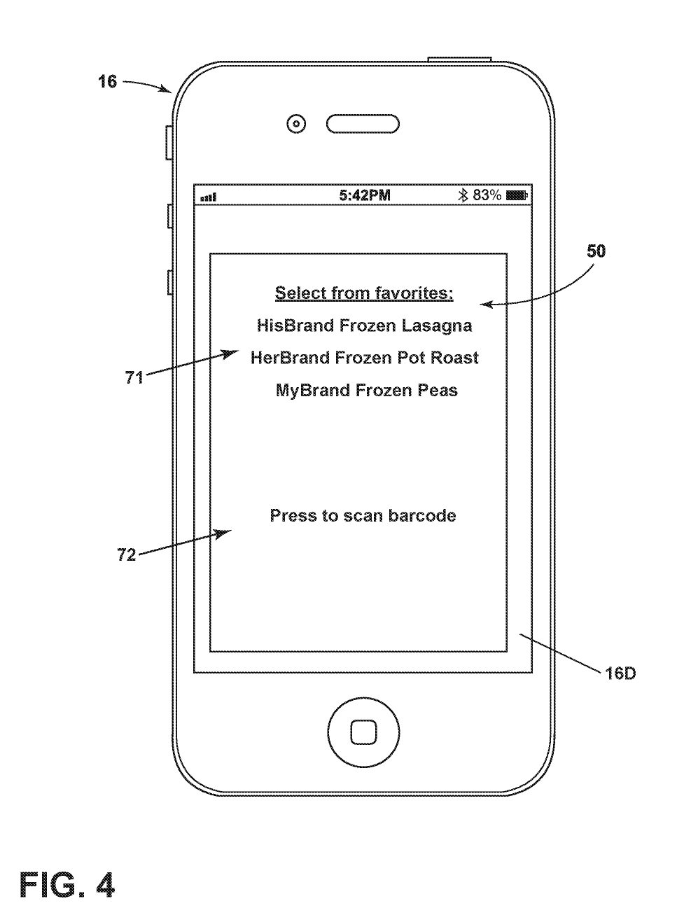

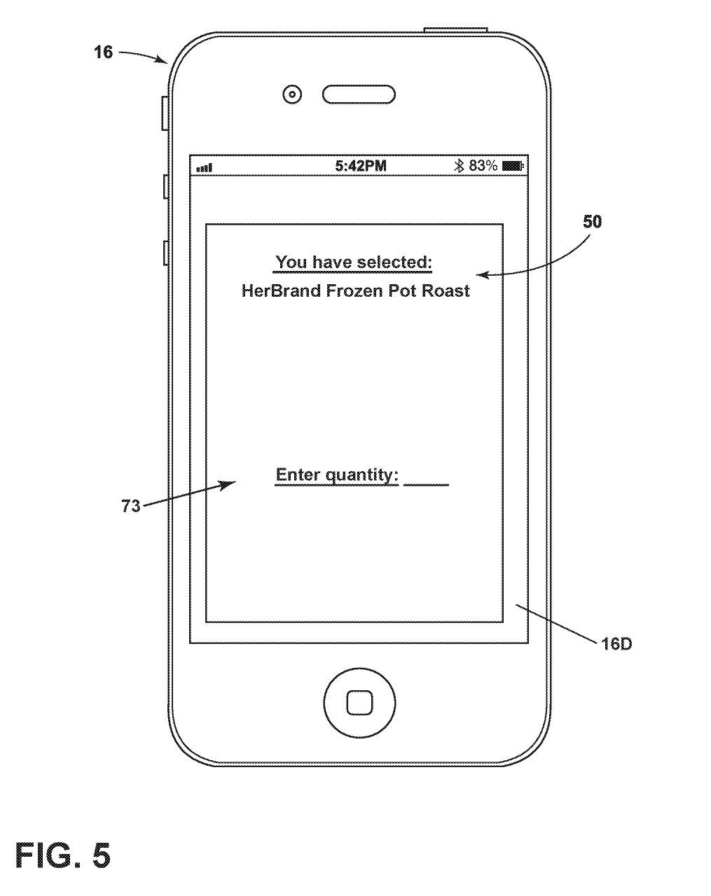

Turning to FIG. 4, an exemplary view on the interactive display 16D of the mobile device 16 illustrates that a user can select from a list 71 of favorite food items, or select a barcode scanner 72 to activate the imaging device 16S (FIG. 1). In FIG. 5, the interactive display 16D can indicate the user's selected option by way of a text listing, product code, or visual image of the food item 30. The quantity of food items 30 can be entered at 73 by tapping on a number or entry using an on-screen keyboard in non-limiting examples.

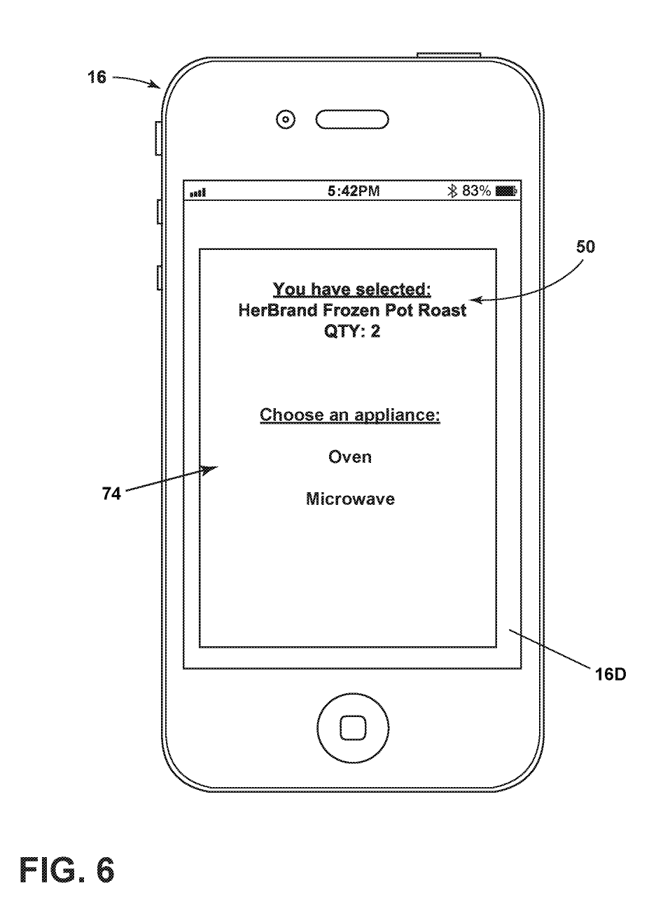

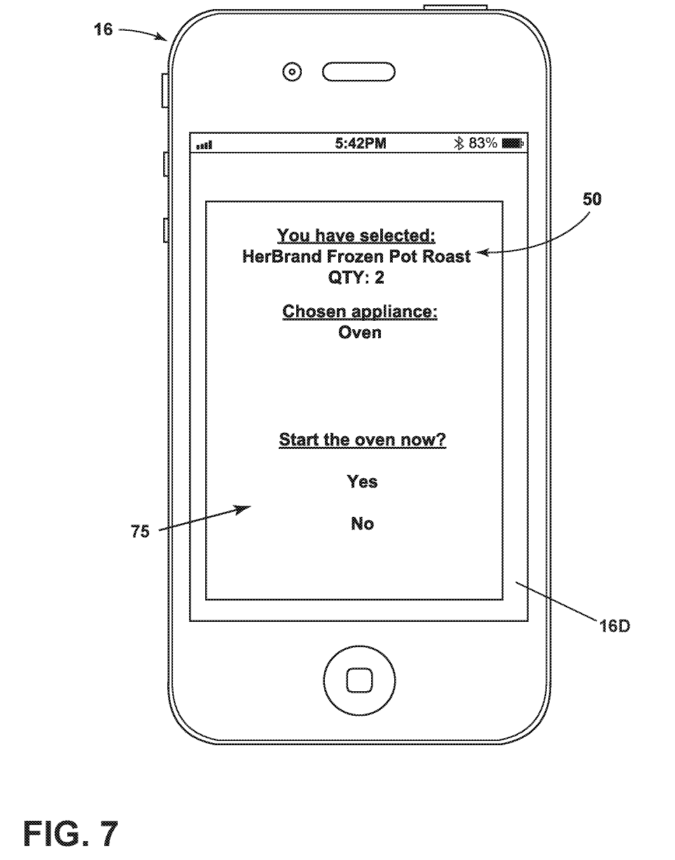

FIG. 6 shows the interactive display 16D verifying the type and quantity of a selected food item 30. In a case where more than one appliance is available to cook the food item 30, an appliance list 74 can be presented for selection of an appliance 14 (FIG. 2) by a user. In FIG. 7, the interactive display 16D can verify the type and quantity of a selected food item 30 as well as the selected appliance 14, and a prompt 75 can be displayed to start the appliance 14 remotely if desired.

While illustrated in FIGS. 4-7 using the mobile device 16, it should be understood that the software application 20 can also be implemented in an appliance 14 or other device or console (not illustrated). Furthermore, any or all of the user prompts 71, 72, 73, 74, 75 can be implemented in a combination of devices, such as using the mobile device 16 for the prompts 71, 72, 73 while using the appliance 14 for the prompts 74, 75, in non-limiting examples.

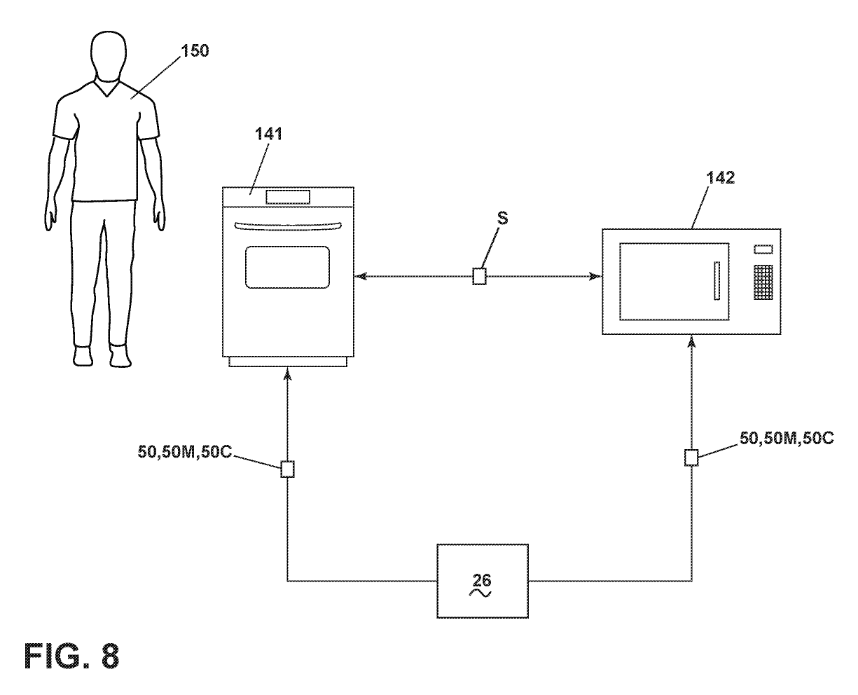

FIG. 8 illustrates two appliances in the network 10 (FIG. 1), shown as an oven 141 and a microwave 142. It is contemplated that in a case where more than one appliance is capable of cooking the food item 30, such as the oven 141 and microwave 142, one or more of the cooking instructions 50, 50M, 50C can be transmitted to all appliances 141, 142 until one is selected for cooking the food item 30. The selection can be made through the application 20 at the prompt 74 (FIG. 6), or by a user 150 interacting with one appliance such as the oven 141 by pressing a button or opening a door, in non-limiting examples. Once selected, the oven 141 can transmit a signal S to all non-selected appliances such as the microwave 142 indicating its operations state of being selected for cooking. It is further contemplated that the transmitted cooking instructions 50, 50M, 50C can be stored in a local memory of the appliances 141, 142 for later recall, or that the non-selected appliances can delete the transmitted cooking instructions 50, 50M, 50C from local memory. It will be understood that while two appliances are shown in the example of FIG. 8, any number of appliances 14 can be included in the network 10.

A method of implementing the cooking instructions 50, 50M, 50C by way of the application 20 (FIG. 2) executed on the mobile device 16 can comprise receiving on the processor 16P (FIG. 1) an input from the application 20, such as the barcode 32 (FIG. 2). The database 40 (FIG. 2) can be queried for the cooking instructions 50 associated with the barcode 32, and the cooking instructions 50 can be converted into modified cooking instructions 50M or custom cooking instructions 50C. The cooking instructions 50, 50M, 50C can be output to a desired location, such as formatting for use in the appliance 14 or the mobile device 16 as described above. The appliance 14 or mobile device 16 can then receive the cooking instructions 50, 50M, 50C.

It can be appreciated that aspects of the present disclosure can provide for a more automated and customized cooking process, where scanning a barcode on a selected prepackaged food item can transmit the cooking instructions to a chosen appliance, and the cooking instructions can be simplified to reduce or remove user intervention steps compared with traditional methods of food preparation.

To the extent not already described, the different features and structures of the various embodiments can be used in combination, or in substitution with each other as desired. That one feature is not illustrated in all of the embodiments is not meant to be construed that it cannot be so illustrated, but is done for brevity of description. Thus, the various features of the different embodiments can be mixed and matched as desired to form new embodiments, whether or not the new embodiments are expressly described. All combinations or permutations of features described herein are covered by this disclosure.

This written description uses examples to disclose the invention, including the best mode, and also to enable any person skilled in the art to practice the invention, including making and using any devices or systems and performing any incorporated methods. The patentable scope of the invention is defined by the claims, and may include other examples that occur to those skilled in the art. Such other examples are intended to be within the scope of the claims if they have structural elements that do not differ from the literal language of the claims, or if they include equivalent structural elements with insubstantial differences from the literal languages of the claims.

What is claimed is:

1. A software application for generating cooking instructions for a food item, the software application comprising:
an input module comprising executable instructions to receive an input identifying the food item;
a query module comprising executable instructions to query a cooking instruction database based on the input and return cooking instructions for the food item;
a conversion module comprising executable instructions that convert the cooking instructions to modified cooking instructions; and
an output module comprising executable instructions outputting the modified cooking instructions.

2. The software application of claim 1 further comprising a display module configured to display the modified cooking instructions.

3. The software application of claim 2 wherein the modified cooking instructions are further modified by user input to create custom cooking instructions.

4. The software application of claim 3 wherein the custom cooking instructions are transmitted to an appliance.

5. The software application of claim 1 wherein the modified cooking instructions are transmitted to an appliance.

6. The software application of claim 5 wherein the appliance comprises one of an oven, toaster oven, cooktop, or microwave.

7. The software application of claim 1 wherein the input comprises a barcode.

8. The software application of claim 1 wherein the conversion module converts cooking instructions including a preheat step into modified cooking instructions that do not include a preheat step.

9. The software application of claim 1 further comprising a remote start module for remote starting an appliance by user input.

10. The software application of claim 1 wherein the conversion module converts multiple-step cooking instructions into single-step cooking instructions.

11. A system of networked appliances for implementing cooking instructions for a prepackaged food item in a cooking appliance, comprising:
an imaging device configured to read an input associated with the prepackaged food item;
a cooking instruction database comprising a list of prepackaged food cooking instructions;
a query module comprising executable instructions to query the cooking instruction database based on the input and return cooking instruction for the prepackaged food item;
a conversion module comprising executable instructions that convert the cooking instructions to modified cooking instructions; and
at least one appliance configured to receive the modified cooking instructions.

12. The system of claim 11 further comprising a transmission module comprising executable instructions to transmit the modified cooking instructions to multiple appliances.

13. The system of claim 12 wherein one of the multiple appliances communicates an operations state to another of the multiple appliances.

14. The system of claim 11 further comprising a mobile device configured to modify the modified cooking instructions by user input to create custom cooking instructions.

15. The system of claim 14 further comprising a custom library configured to store the custom cooking instructions.

16. The system of claim 14 wherein the mobile device remote starts the at least one appliance.

17. The system of claim 11 wherein the conversion module converts multiple-step cooking instructions into single-step cooking instructions.

18. The system of claim 11 wherein the at least one appliance comprises one of an oven, toaster oven, cooktop, or microwave.

19. A method of implementing cooking instructions on prepackaged foods by way of an application executed on a mobile device, the method comprising:
receiving on a processor an input from the application;
querying a database for a list of cooking instructions associated with the input;
converting the cooking instructions into modified cooking instructions for use in a non-preheated appliance;
outputting the modified cooking instructions; and
receiving the modified cooking instructions in one of an appliance or a mobile device.

20. The method of claim 19 wherein the appliance is one of an oven, toaster oven, cooktop, or microwave.

21. The method of claim 19 wherein the appliance displays the modified cooking instructions.

22. The method of claim 21 wherein the modified cooking instructions include a cooking time and temperature.

23. The method of claim 22 wherein the modified cooking instructions are implemented by user input on the appliance.

24. The method of claim 23 wherein the user input comprises pressing a start button on the appliance.

25. The method of claim 19 wherein the receiving the modified cooking instructions comprises receiving the modified cooking instructions in multiple appliances.

26. The method of claim 19 wherein the input comprises one of a barcode or QR code.

27. The method of claim 19 wherein the modified cooking instructions can be altered by user input on one of the appliance or mobile device.
